(19) United States
(12) Patent Application Publication
(10) Pub. No.: US 2025/0098069 A1
(43) Pub. Date: Mar. 20, 2025

(54) INFORMATION PROCESSING APPARATUS

(71) Applicant: Toshiba Tec Kabushiki Kaisha, Tokyo (JP)

(72) Inventor: Takahiro OGISU, Izunokuni Shizuoka (JP)

(21) Appl. No.: 18/789,614

(22) Filed: Jul. 30, 2024

(30) Foreign Application Priority Data
Sep. 15, 2023 (JP) 2023-150494

(51) Int. Cl. H05K 1/14

(52) U.S. Cl. CPC H05K 1/141; H05K 1/142

(57) ABSTRACT

A store system includes a plurality of point-of-sale (POS) terminals each installed at a store; and an edge device connectable to the POS terminals via a store network for executing sales data processing on sales data generated by the POS terminals. The edge device includes a plurality of circuit boards, each of which can operate as a primary board or a secondary board and is configured to, when operating as the primary board: acquire a request for executing the sales data processing from a POS terminal, assign the sales data processing to another circuit board that is operating as the secondary board, and output a result of the sales data processing to the POS terminal.

### CROSS-REFERENCE TO RELATED APPLICATION(S)

This application is based upon and claims the benefit of priority from Japanese Patent Application No. 2023-150494, filed Sep. 15, 2023, the entire contents of which are incorporated herein by reference.

### FIELD

Embodiments described herein relate generally to an information processing apparatus.

### BACKGROUND

Conventionally, in an enterprise that operates a plurality of stores, data collected at each store is transmitted to a server (for example, a cloud server), which performs a process for analyzing the collected data.

In recent years, in order to achieve distributed data processing and reduce the amount of data transmission, an information processing apparatus such as an edge gateway or an edge server (hereinafter, collectively referred to as an edge device) has been introduced in an individual store to perform the data analysis locally.

Some edge devices have a plurality of circuit boards for executing a plurality of different processes in parallel. In such edge devices, each process can be performed by a corresponding one of the circuit boards.

However, since each circuit board is mounted in a slot of the main board of the edge device such as a motherboard and performs the process under the control of the main board, there are restrictions on circuit boards that can be added. For example, it is difficult to add a new circuit board to an edge device such as a personal computer (PC) that is already operating in an existing system. Therefore, there is room for improving the scalability of an edge device.

### SUMMARY OF THE INVENTION

Embodiments of the present disclosure improve scalability of an information processing apparatus for performing different data processes using a plurality of circuit boards.

In one embodiment, a store system comprises a plurality of point-of-sale (POS) terminals each installed at a store; and an edge device connectable to the POS terminals via a store network for executing sales data processing on sales data generated by the POS terminals. The edge device includes a plurality of circuit boards, each of which can operate as a primary board or a secondary board and is configured to, when operating as the primary board: acquire a request for executing the sales data processing from a POS terminal, assign the sales data processing to another circuit board that is operating as the secondary board, and output a result of the sales data processing to the POS terminal.

### BRIEF DESCRIPTION OF THE DRAWINGS

FIG. 1 is a diagram illustrating a configuration of a store system according to an embodiment.

FIG. 2 is a diagram of a hardware configuration of an edge device according to an embodiment.

FIG. 3 is a diagram of a hardware configuration of a circuit board included in the edge device.

FIG. 4 is a diagram of a functional configuration of circuit boards included in the edge device.

FIG. 5 is a diagram illustrating an example of a selection screen according to an embodiment.

FIG. 6 is a sequence diagram of a process performed by a master board and a slave board according to an embodiment.

FIG. 7 is a flowchart of a configuration change detection process executed by the master board.

### DETAILED DESCRIPTION

Hereinafter, embodiments will be described in detail with reference to the drawings. The present disclosure is not limited to the embodiments described below.

Hereinafter, an information processing apparatus according to an embodiment will be described in detail with reference to the accompanying drawings. In the following embodiments, an edge device used in a store will be described as an example of the information processing apparatus. Note that embodiments of this disclosure are not limited to this example.

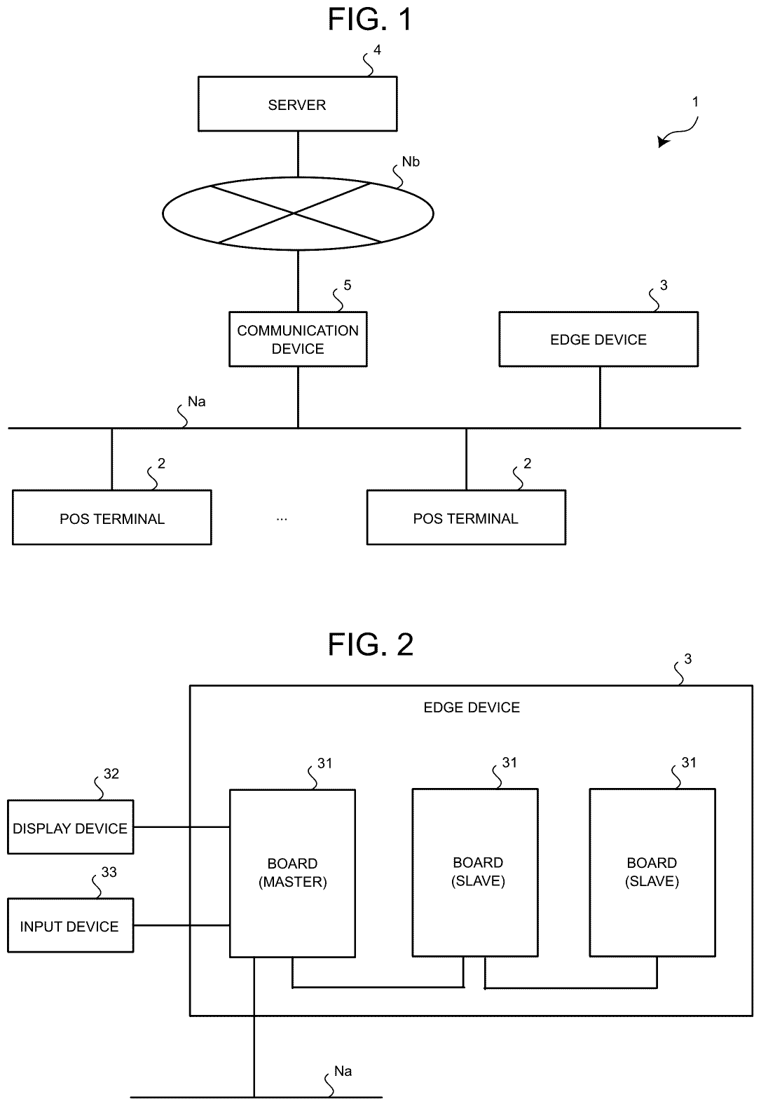

FIG. 1 is a diagram illustrating an example of a configuration of a store system 1 according to an embodiment. As illustrated in FIG. 1, the store system 1 includes a plurality of POS terminals 2, an edge device 3, a server 4, and a communication device 5. The POS terminals 2 and the edge device 3 are communicably connected via a network Na. Further, the edge device 3 is communicably connected to the servers 4 via a network Nb through the communication device 5 such as a router connected to the network Na.

Here, the network Na is, for example, a network such as a local area network (LAN) provided in a store. The network Nb is, for example, a network such as the Internet, a virtual private network (VPN), a public communication network, or a mobile communication network.

The POS terminal 2 is an exemplary item sales data processing apparatus provided in a store. One or more POS terminals 2 are provided in the store, and execute a data process related to a commercial transaction of an item purchased by a customer.

The edge device 3 is an example of an information processing apparatus. The edge device 3 receives a processing request from the POS terminal 2 or the like connected to the network Na, and executes various kinds of information processing instructed by the processing request. It is assumed that the processing request includes not only data to be processed but also information for instructing a method of processing and the like.

The server 4 is a server device for managing data generated at a plurality of stores. The server 4 is provided in a headquarters or the like of a company that operates the stores, and is communicably connected to the edge device 3 of each store. Note that the server 4 may be a single device or a cloud server or a cloud system including a plurality of devices connected via a network.

Next, a configuration example of the above-described edge device 3 will be described. First, the hardware configuration of the edge device 3 will be described with reference to FIG. 2.

As shown in FIG. 2, the edge device 3 includes a plurality of circuit boards 31 (hereinafter simply referred to as boards 31). Each of the boards 31 includes a processor such as a central processing unit (CPU) and a memory, and can operate independently. Each of the boards 31 has a communication interface compliant with a general-purpose interface standard such as a Universal Serial Bus (USB) connector or a LAN connector, and is connected to each other via the communication interface so as to be able to communicate with each other.

As described above, the edge device 3 of the present embodiment can be formed by connecting a plurality of boards 31 with a general-purpose communication interface. Therefore, since the edge device 3 can be formed using various boards 31, versatility can be improved. For example, a new board can be added to an edge device 3 such as a PC that has been operated in an existing system. Therefore, it is possible to improve scalability of the edge device 3.

In FIG. 2, the boards 31 are daisy chained, but the present disclosure is not limited thereto, and may be connected in a bus-type or star-type connection form (network topology) via a switching hub, a USB hub, or the like.

Further, at least one of the plurality of boards 31 is connected to the network Na via a connecting interface. In the present embodiment, the master board 31 to be described later is connected to the network Na.

Further, at least one of the plurality of boards 31 has an interface for display such as High-Definition Multimedia Interface (HDMI)®, and an interface for an input device such as a keyboard, and is connected to a display device 32 and an input device 33. In the present embodiment, it is assumed that the display device 32 and the input device 33 are connected to the board 31 of the master to be described later.

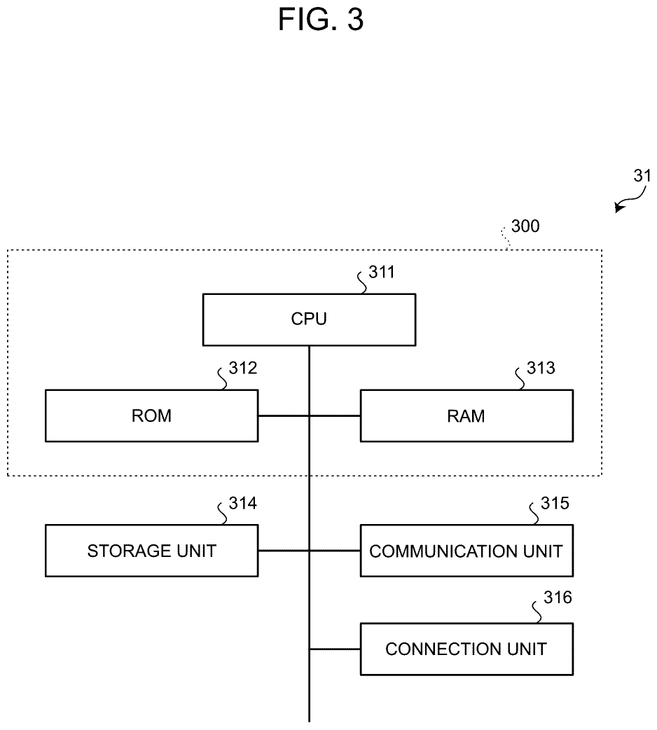

Next, an example of the hardware configuration of the board 31 will be described. FIG. 3 is a diagram illustrating an example of the hardware configuration of the board 31 included in the edge device 3. As illustrated in FIG. 3, the board 31 includes a CPU 311, a read only memory (ROM) 312, a random access memory (RAM) 313, a storage unit 314, a communication unit 315, and a connection unit 316.

The CPU 311 is an exemplary processor. The ROM 312 stores various programs. The RAM 313 is a workspace for loading programs and storing various types of data.

The CPU 311, the ROM 312 and the RAM 313 are connected to each other via a bus or the like, and constitute a controller 300. The controller 300 executes various processes in accordance with a program stored in the ROM 312 or the storage unit 314 and loaded onto the RAM 313.

The storage unit 314 is an auxiliary storage device such as a hard disk drive (HDD) or a flash memory. The storage unit 314 stores setting information and programs that can be executed in addition to basic software such as an operating system (OS). For example, the storage unit 314 stores programs and setting information for cooperation with the other boards 31. In addition, the storage unit 314 stores programs and installation information related to processing to be executed by the board 31.

The communication unit 315 is a network interface circuit that controls communication with other devices. For example, the communication unit 315 controls communication with the other boards 31. The communication unit 315 controls communication with an external device such as the server 4.

The connection unit 316 includes a display interface circuit and an input interface circuit for controlling input and output of various kinds of information from and to the display device 32 and the input device 33. For example, the connection unit 316 outputs display information to the display device 32. For example, the connection unit 316 receives the input of operation information indicating the input operation from the input device 33.

The specifications and configurations of the plurality of boards 31 may be the same or different. For example, some of the boards 31 may be mounted with dedicated circuitry such as an application specific integrated circuit (ASIC) not mounted on the other boards 31 or hardware configurations such as accelerators. The OS mounted on some of the boards 31 may differ in type and version from OS mounted on the other boards 31.

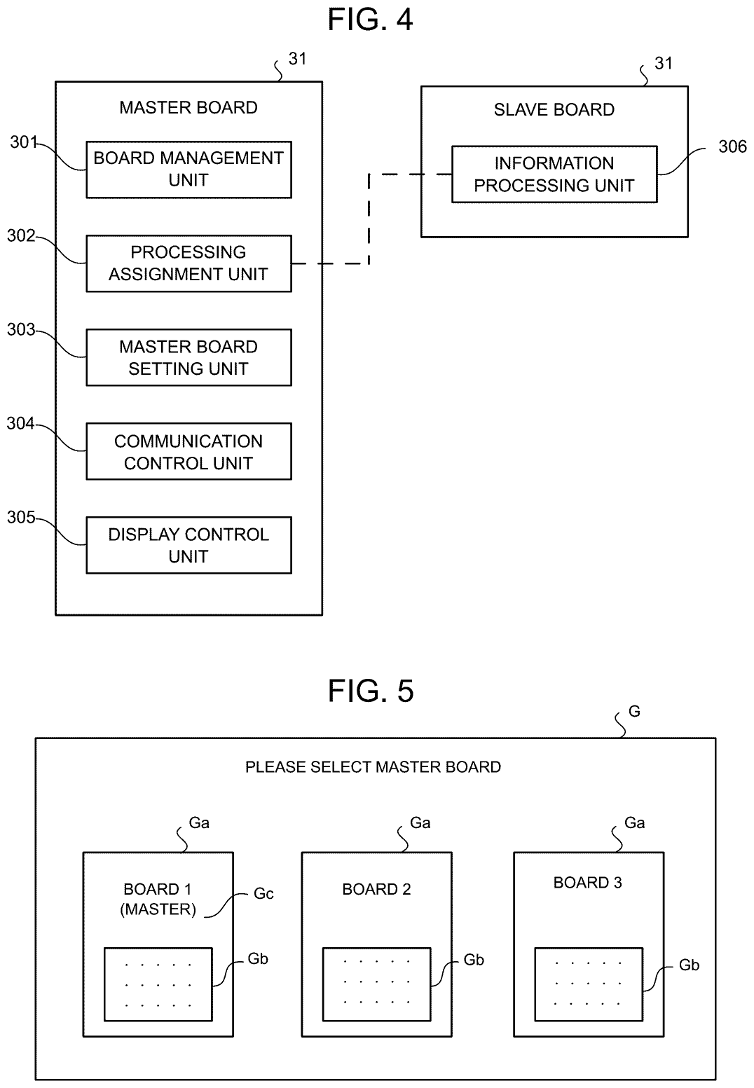

Next, a functional configuration of the board 31 will be described with reference to FIG. 4. In FIG. 4, a functional configuration of a master board 31 and a functional configuration of a slave board 31 will be described separately.

Here, the master board 31 is the board 31 set as the master device among the other boards 31, and manages and controls the other boards 31. The master board 31 may be referred to as the primary board. The setting of the master device may be set by a user of the edge device 3 or may be set automatically. In the latter case, for example, the board 31 to which the display device 32 and the input device 33 are connected may be set as the master board or may be randomly set. In addition, the slave board 31 is each of the boards 31 other than the master board 31, and executes processing under control of the master board 31. The slave board may be referred to as a secondary board. It is assumed that any of the boards 31 can operate as either a master board or a slave board.

As illustrated in FIG. 4, the master board 31 has the functions of a board management unit 301, a processing assignment unit 302, a master board setting unit 303, a communication control unit 304, and a display control unit 305.

The functions of the master board 31 are performed by the CPU 311 of the board 31 in accordance with a program stored in the ROM 312 or the storage unit 314, but the present disclosure is not limited thereto.

The board management unit 301 acquires specification information indicating the specification of each slave board 31 therefrom, and stores and manages the specification information in the storage unit 314. For example, the board management unit 301 acquires, from each of the slave boards 31, specification information indicating specifications, characteristics, and the like of hardware resources and software resources of the slave board 31. Note that the board management unit 301 may be configured to acquire and manage specification information of its own board 31 (i.e., the master board 31) in the same manner.

Note that the timing at which the board management unit 301 acquires the specification information is not particularly limited. For example, the board management unit 301 may be configured to acquire the specification information from each of the boards 31 at the time of activation of the edge device 3, or may be configured to acquire the specification information at predetermined time intervals (such as every hour). Further, the board management unit 301 may be configured to acquire the specification information from each of the boards 31 when it is detected that the configuration of the board 31 has been changed based on the communication between the boards 31. Specifically, the board management unit 301 acquires the specification information from each of the boards 31 when a board 31 is added, removed, or replaced.

The processing assignment unit 302 receives a processing request from an external device such as the POS terminal 2, and performs a process of allocating the received processing request to each of the boards 31. Specifically, the processing assignment unit 302 assigns processing to the board 31 based on an assignment table in which the processing requested by the processing request is associated with one of the boards 31.

Here, the requested processing is not particularly limited, and may be, for example, processing of aggregating sales based on transaction data for one day, processing of predicting a demand for analyzing a purchase tendency or a number of purchases of a product, or the like. Further, the processing may be image analysis processing of a monitoring camera that captures an image of the inside of the store or processing related to creation of a machine learning model for performing image analysis. The assignment table may be set in advance, or may be set automatically or manually.

When the assignment table is automatically set, for example, the processing assignment unit 302 may assign processing to be executed by each board 31 based on the specification information managed by the board management unit 301. Specifically, the processing assignment unit 302 assigns suitable processing to each board 31 based on the presence/absence of an additional function such as a dedicated circuit or an accelerator, such as a processing capacity or an ASIC, of each board 31 indicated in the specification information.

In this case, the automatic setting of the assignment table can be efficiently performed by including, in the processing requested from the external device, an identifier indicating the type of the processing and a condition (hereinafter, also referred to as a specification condition) relating to the specification of the board 31 suitable for executing the processing. For example, the board management unit 301 compares the specification conditions included in the processing request with the specifications of the respective boards 31 indicated in the specification information, and sets an assignment table in which the identifier of the processing request is associated with the board 31 satisfying the specification conditions of the processing request.

In the case where the assignment table is manually set, the processing assignment unit 302 may cause the display device 32 to display a screen for supporting the setting of the assignment table by cooperating with the display control unit 305 described later. For example, the processing assignment unit 302 may control the display device 32 to display a screen indicating the specifications of the respective boards 31 and the processing that can be executed by the respective boards 31, based on the specification information managed by the board management unit 301. Accordingly, the operator who manually sets the assignment table can create the assignment table while viewing the screen displayed on the display device 32, so that the processing assignment unit 302 can support creation of the assignment table.

Note that the processing assignment unit 302 may be configured to dynamically determine the board 31 in response to a processing request from an external device, regardless of the assignment table. In this case, the processing assignment unit 302 allocates the processing of the processing request to the board 31 satisfying the specification condition, for example, by transmitting the processing request including the specification condition.

Further, the processing assignment unit 302 assigns the processing requested by the external device to the board 31, and causes the board 31 to execute the processing, and acquires the processing result from the board 31 of the assignment destination. Then, the processing assignment unit 302 returns the processing result to the external device of the request source that requested the processing. Note that the processing result processed by the board 31 is not limited to the form of returning to the requesting external device, and may be transmitted to the higher-level server 4.

The master board setting unit 303 is a functional unit for setting a board 31 to be the master board 31. Specifically, the master board setting unit 303 cooperates with the display control unit 305 to cause the display device 32 to display a screen on which the board 31 serving as the master board can be selected.

As an example, the master board setting unit 303 controls the display device 32 to display a selection screen in which each of the boards 31 is displayed in a list in a selectable state. Further, the master board setting unit 303 may control the display device 32 to display the specifications of each board 31 and the processing execute by each board 31 on the selection screen based on the specification information managed by the board management unit 301.

FIG. 5 is a diagram illustrating an example of such a selection screen G for selecting the master board. As illustrated in FIG. 5, in the selection screen G, board images Ga representing the boards 31 are displayed in an identifiable manner. In FIG. 5, the boards 31 can be identified by displaying “board 1” to “board 3” on the board images Ga of the three boards 31.

Further, on each of the board images Ga, the specification information Gb of the corresponding board 31 is displayed. Further, on the board images Ga corresponding to the main board, information Gc indicating the main board is displayed.

Here, each of the board images Ga functions as a selectable user interface component. The operator can set the board 31 corresponding to the selected board image Ga as the main board by selecting any one of the board image Ga via the input device 33.

Specifically, the master board setting unit 303 accesses the selected board 31 and performs setting (hereinafter, also referred to as master setting) for causing the board 31 to function as the master board. For example, the master board setting unit 303 performs master setting on the setting information held by the storage unit 314 of the selected board 31. When the board 31 other than the own board 31 is selected as the master board, the master board setting unit 303 cancels the master setting set on the own board 31.

The board 31 on which the master setting is performed functions as the master board at the time of the next activation of the edge device 3. Further, the board 31 whose master setting has been cancelled functions as a slave board 31 at the time of the next start-up of the edge device 3.

Note that the timing at which the selection screen is displayed is not limited to the timing where an instruction is received from the operator. For example, when detecting that the configuration of the board 31 has been changed, the master board setting unit 303 may control the display device 32 to display a selection screen G of the master board. Specifically, the master board setting unit 303 may control the display device 32 to display a selection screen G of the master board together with a message notifying that the configuration has been changed when the addition or removal of a board 31, the replacement with another board 31, or the like is performed. The configuration change of the board 31 can be detected based on, for example, communication between the boards 31 or specification information acquired by the board management unit 301.

When another board 31 is selected as the master board, the master board setting unit 303 may move or copy the assignment table held in the storage unit 314 to the storage unit 314 of the board 31 selected as the master board. As a result, the contents of the existing assignment table can be transferred to the new master board, so that the convenience when the master board is switched can be improved.

Referring back to FIG. 4, the communication control unit 304 controls the communication function of the slave board 31. Specifically, the communication control unit 304 controls the slave board 31 to suppress communication other than the inter-board communication, that is, communication between the slave board 31 and an external device. Here, the control method of the slave board 31 is not particularly limited, and various methods can be adopted.

For example, the communication control unit 304 may control the communication unit 315 to transmit an access control list in which addresses (e.g., IP addresses, MAC addresses, and the like) of the respective boards 31 are registered to the slave boards 31, and block communication from addresses other than the addresses registered in the access control list.

As described above, by limiting the communication target of the slave board 31, it is possible to prevent direct access from an external device to the slave board 31. As a result, the security of the slave board 31 can be improved, so that the edge device 3 can be stably operated.

In the configuration of FIG. 2, only the master board 31 is connected to the network Na, and each slave board 31 is physically disconnected from the network Na. In such a configuration, the communication control unit 304 may be unnecessary. However, when a plurality of boards 31 are connected by a bus type or the like, there is a possibility that direct access from an external device to the slave board 31 is performed, and therefore, it is preferable to suppress direct access from the external device to the slave board 31 under the control of the communication control unit 304.

The display control unit 305 controls a screen to be displayed on the display device 32. Specifically, the display control unit 305 causes the display device 32 to display a screen for supporting the operation of the edge device 3 by cooperating with other functional configurations. For example, the display control unit 305 causes the display device 32 to display a screen for supporting the setting of the assignment table and the selection screen G for selecting the master board 31.

On the other hand, as illustrated in FIG. 4, the slave board 31 has the function of an information processing unit 306. The function of the slave board 31 is performed by the CPU 311 of the board 31 in accordance with a program stored in the ROM 312 or the storage unit 314, but the present disclosure is not limited thereto.

The information processing unit 306 executes processing assigned to its own board 31 by the processing assignment unit 302 of the master board 31. When the processing assigned to the board 31 is executed, the information processing unit 306 outputs the processing result to the processing assignment unit 302 of the master board 31. Then, as described above, the processing assignment unit 302 of the master board 31 controls the communication unit 315 to transmit the processing result obtained from the board 31 to the requesting external device or the server 4.

In the functional configuration of FIG. 4, the master board 31 does not include the information processing unit 306, but the present disclosure is not limited thereto, and the main board 31 may also include the information processing unit 306 when processing is performed on the main board 31.

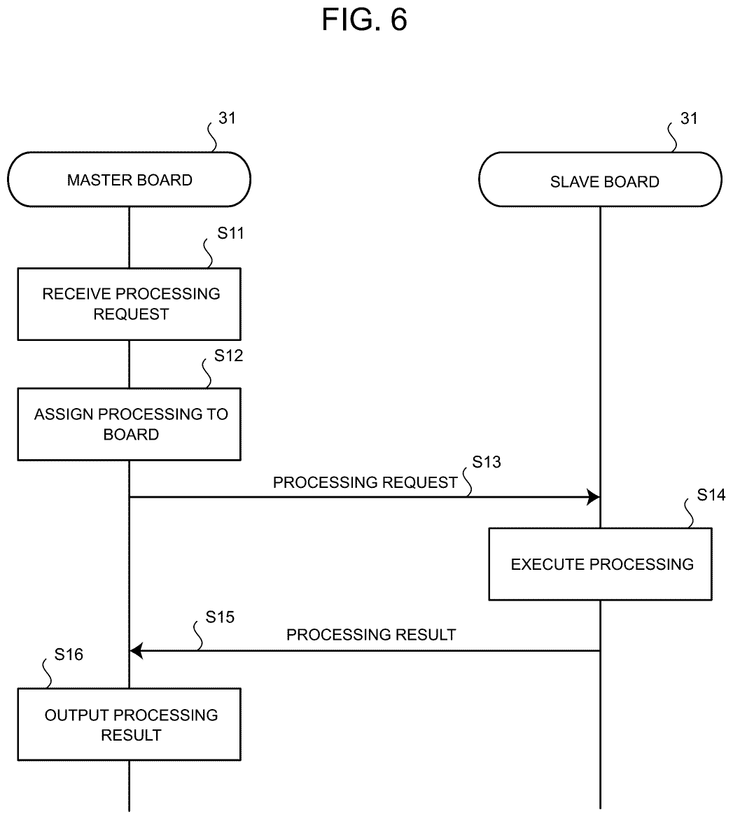

Hereinafter, an operation example of the edge device 3 will be described. FIG. 6 is a sequence diagram illustrating an example of processing performed between a master board 31 and a slave board 31. It is assumed that the assignment table has already been set in advance.

First, upon receiving a processing request from an external device (step S11), the processing assignment unit 302 of the master board 31 selects the board 31 to which the processing related to the processing request is assigned based on the processing content of the received processing request and the assignment table (step S12). Next, the processing assignment unit 302 outputs the data to be processed and the process details transmitted in the processing request to the board 31 set in the step S12 (step S13). Note that FIG. 6 illustrates an example in which processing is assigned to one of the slave boards 31.

On the other hand, the information processing unit 306 of the slave board 31 serving as the assignment destination executes the processing instructed by the processing request when the data to be processed is received from the master board 31 (step S14). When the processing is completed, the information processing unit 306 outputs the processing result of the processing to the master board 31 (step S15).

When the processing result is acquired from the slave board 31 selected in the step S12, the processing assignment unit 302 of the master board 31 outputs or returns the processing result to the external device or the like of the request source that requested the processing (step S16).

As described above, in the edge device 3, each time the master board 31 receives a processing request from an external device, any of the boards 31 executes the processing instructed by the processing request, and the master board 31 outputs the processing result of the external device or the like of the request source. As a result, in the external device requesting the processing, the processing result of the requested processing can be acquired by transmitting the processing request to the edge device 3 without being conscious of the presence of the plurality of boards 31. Therefore, processing using the edge device 3 can be easily performed.

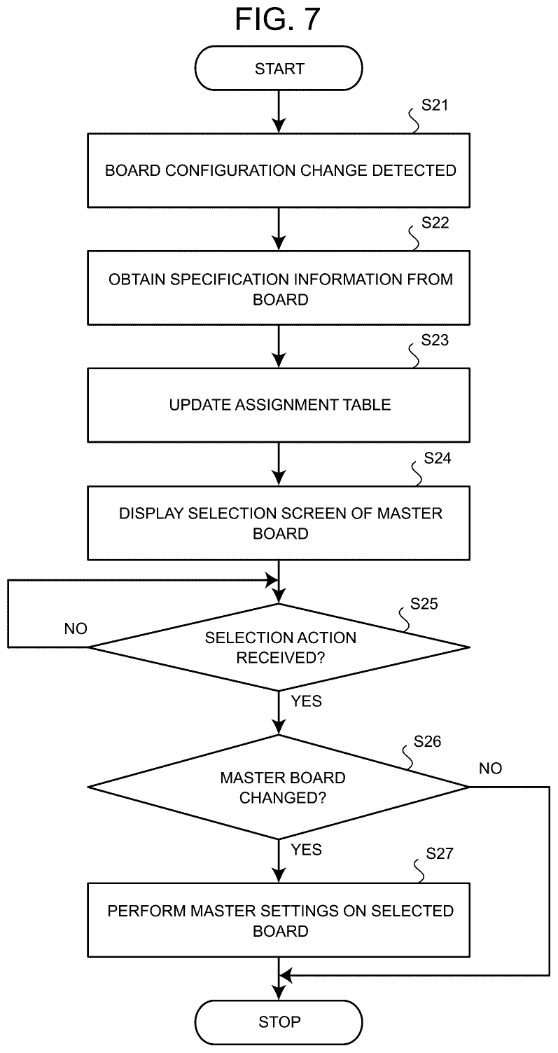

Next, an example of a configuration change detection process executed by the master board 31 of the edge device 3 will be described with reference to FIG. 7. FIG. 7 is a flowchart illustrating an example of the configuration change detection process executed by the master board 31.

When the configuration of the board 31 is changed, such as adding or removing a board 31 or exchanging an existing board 31 with another board 31, the board management unit 301 detects that the configuration has been changed (step S21). Next, the board management unit 301 acquires specification information from each of the boards 31, stores the specification information in the storage unit 314, and manages the specification information (step S22).

Next, the processing assignment unit 302 updates the assignment table by assigning processing to be executed to each of the boards 31 based on the specification information acquired in the step S22 (step S23). In addition, the master board setting unit 303 causes the display device 32 to display a selection screen G (see FIG. 5) in cooperation with the display control unit 305 (step S24), and waits for an operation from the operator (step S25).

When the master board 31 is selected by an operation from the operator (step S25, Yes), the master board setting unit 303 determines whether the master board 31 has been changed (step S26). Here, when it is determined that the master board 31 has not been changed (step S26, No), the master board setting unit 303 ends this process.

When it is determined in step S26 that the master board 31 has been changed (step S26, Yes), the master board setting unit 303 performs master setting on the board 31 selected as the master board (step S27), and ends this process.

As described above, the edge device 3 of the present embodiment includes a plurality of boards 31 connected in a mutually communicable connection form, and one of the plurality of boards 31 functions as the master board 31. Upon receiving a processing request to be executed from an external device, the master board 31 assigns the processing instructed by the processing request to any one of the boards 31, and outputs the processing result processed by the board 31 of the assignment destination.

Thus, in the edge device 3 of the present embodiment, it is possible to execute communication requested from an external device while allocating the processing to each of a plurality of boards 31 connected in a mutually communicable connection form. Therefore, in the present embodiment, it is possible to improve the convenience of the edge device 3 that performs processing using the plurality of boards 31.

Programs executed by the apparatuses of the above-described embodiments (and modifications) are provided in advance in the ROM 312, the storage unit 314, or the like. The programs executed by the apparatuses of the above-described embodiments may be provided by being recorded in a computer-readable recording medium such as a CD-ROM, a flexible disk (FD), or a CD-R, a Digital Versatile Disk (DVD) in an installable format or an executable format.

Further, the program executed by each apparatus of the above-described embodiment may be stored in a computer connected to a network such as the Internet, and may be downloaded via the network. Further, the program executed by each apparatus of the above-described embodiment may be provided or distributed via a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A store system comprising:
a plurality of point-of-sale (POS) terminals each installed at a store; and
an edge device connectable to the POS terminals via a store network for executing sales data processing on sales data generated by the POS terminals, wherein
the edge device includes a plurality of circuit boards, each of which can operate as a primary board or a secondary board and is configured to, when operating as the primary board:
acquire a request for executing the sales data processing from a POS terminal,
assign the sales data processing to another circuit board that is operating as the secondary board, and
output a result of the sales data processing to the POS terminal.

2. The store system according to claim 1, wherein each of the circuit boards is configured to, when operating as the primary board:
acquire specification information indicating specifications of the other circuit boards, and
based on the acquired specification information, determine one of the other circuit boards to which the sales data processing is to be assigned.

3. The store system according to claim 2, wherein each of the circuit boards is configured to, when operating as the primary board:
determine whether one of the circuit boards has been removed from the edge device or another circuit board has been added to the edge device, and
upon determining that one of the circuit boards has been removed from the edge device or another circuit board has been added to the edge device, determine to acquire the specification information.

4. The store system according to claim 1, wherein each of the circuit boards is configured to, when operating as the primary board, manage communication between the other circuit boards and the POS terminals.

5. The store system according to claim 4, wherein each of the circuit boards is configured to, when operating as the primary board, block communication from the POS terminals to the other circuit boards.

6. The store system according to claim 4, wherein the circuit board that is operating as the primary board is connected to the store network.

7. The store system according to claim 1, wherein
the edge device includes a display and an input device, and
each of the circuit boards is configured to, when operating as the primary board, control the display to display a screen by which one of the circuit boards can be selected as the primary board.

8. The store system according to claim 7, wherein the screen shows specifications of each of the circuit boards.

9. The store system according to claim 1, further comprising:
a communication device through which the store network is connected to an external server that manages the sales data processed by the edge device.

10. The store system according to claim 1, wherein the circuit boards are daisy chained.

11. An edge device for executing sales data processing in response to a request from a point-of-sale (POS) terminal, the edge device comprising:
a plurality of circuit boards, each of which can operate as a primary board or a secondary board and is configured to, when operating as the primary board:
acquire a request for executing the sales data processing from the POS terminal,
assign the sales data processing to another circuit board that is operating as the secondary board, and
output a result of the sales data processing to the POS terminal.

12. The edge device according to claim 11, wherein each of the circuit boards is configured to, when operating as the primary board:
acquire specification information indicating specifications of the other circuit boards, and
based on the acquired specification information, determine one of the other circuit boards to which the sales data processing is to be assigned.

13. The edge device according to claim 12, wherein each of the circuit boards is configured to, when operating as the primary board:
determine whether one of the circuit boards has been removed from the edge device or another circuit board has been added to the edge device, and
upon determining that one of the circuit boards has been removed from the edge device or another circuit board has been added to the edge device, determine to acquire the specification information.

14. The edge device according to claim 11, wherein each of the circuit boards is configured to, when operating as the primary board, manage communication between the other circuit boards and the POS terminal.

15. The edge device according to claim 14, wherein each of the circuit boards is configured to, when operating as the primary board, block communication from the POS terminal to the other circuit boards.

16. The edge device according to claim 14, wherein the circuit board that is operating as the primary board is connected to a network to which the POS terminal is connected.

17. The edge device according to claim 11, further comprising:
a display, wherein
each of the circuit boards is configured to, when operating as the primary board, control the display to display a screen by which one of the circuit boards can be selected as the primary board.

18. The edge device according to claim 17, wherein the screen shows specifications of each of the circuit boards.

19. The edge device according to claim 11, wherein the circuit boards are daisy chained.

20. A method performed by an edge device for executing sales data processing in response to a request from a point-of-sale (POS) terminal, the edge device including a plurality of circuit boards, each of which can operate as a primary board or a secondary board, the method comprising:
by one of the circuit boards that is operating as the primary board,
acquiring a request for executing the sales data processing from the POS terminal;
assigning the sales data processing to another circuit board that is operating as the secondary board; and
outputting a result of the sales data processing to the POS terminal.
